(19) United States
(12) Patent Application Publication
(10) Pub. No.: US 2025/0354095 A1
(43) Pub. Date: Nov. 20, 2025

(54) ALCOHOLIC BEVERAGE TO BE IMBIBED AT LOW TEMPERATURE, AND METHOD FOR MANUFACTURING SAME

(71) Applicant: LOTTE CO., LTD., Shinjuku-ku, Tokyo (JP)

(72) Inventors: Yuko KAWAMATA, Saitama-shi (JP); Yosuke SUZUKI, Saitama-shi (JP); Hiroyuki TAKAMATSU, Saitama-shi (JP)

(21) Appl. No.: 18/877,268

(22) PCT Filed: Jun. 20, 2023
(86) PCT No.: PCT/JP2023/022797

§ 371 Date: Dec. 19, 2024

(30) Foreign Application Priority Data
Jun. 24, 2022 (JP) 2022-102251

(51) Int. Cl. C12G 3/04

(52) U.S. Cl. CPC C12G 3/04

(57) ABSTRACT

Provided is an alcoholic beverage to be imbibed at low temperature, which includes cryohydrates and has fluidity under a freezing condition, the alcoholic beverage to be imbibed at low temperature being suppressed in occurrence of the coarsening of the cryohydrates. Specifically, provided is an alcoholic beverage to be imbibed at low temperature including: 2.0 vol % or more of an alcohol; 10 wt % to 85 wt % of cryohydrates each having a major axis length of from 0.01 mm to 5.0 mm; and at least one of 0.021 wt % or more and 0.083 wt % or less of a mannan, or 0.0005 wt % or more and 0.011 wt % or less of agar, wherein the alcoholic beverage to be imbibed at low temperature includes bubbles to have fluidity at a temperature of from −20° C. to −2° C.

### TECHNICAL FIELD

The present invention relates to an alcoholic beverage, and more specifically, to an alcoholic beverage to be imbibed at low temperature, which includes cryohydrates and has fluidity particularly at a product temperature of from −20° C. to −2° C., and a method of manufacturing the beverage.

### BACKGROUND ART

An attempt has heretofore been made to obtain an alcoholic beverage that can be imbibed under a low-temperature condition and has high palatability. In each of Patent Literature 1 and Patent Literature 2, there is a disclosure of an alcoholic beverage including cryohydrates. In each of those patent literatures, there is a disclosure that an alcoholic beverage including an ice piece having such a size as to be perceptible is manufactured by mixing an alcoholic beverage base mix and an ice piece, and subjecting the mixture to aeration.

Meanwhile, an alcoholic beverage has a low freezing temperature because the beverage includes an alcohol. In an alcoholic beverage to be imbibed at low temperature that is commercially available, the coarsening of cryohydrates is liable to occur owing to the following facts: the beverage is susceptible to heat shock due to a temperature fluctuation at the time of its distribution or its storage in a household freezer; and the beverage has a low freezing point. That is, during the freezing storage, the cryohydrates grow or aggregate, and hence the cryohydrates have an unintended size. As a result, such quality deterioration as described below occurs: the mouthfeel of the alcoholic beverage deteriorates; and the fluidity and smoothness thereof are impaired. Accordingly, the alcoholic beverage to be imbibed at low temperature has involved a problem in that the setting of its open date and its inventory control are difficult.

### CITATION LIST

### Patent Literature

PTL 1: Japanese Patent No. 5,102,934
PTL 2: Japanese Patent No. 5,436,312

### SUMMARY OF INVENTION

### Technical Problem

An object of the present invention is to provide an alcoholic beverage to be imbibed at low temperature, which includes cryohydrates and has fluidity under a freezing condition, the alcoholic beverage to be imbibed at low temperature being suppressed in occurrence of the coarsening of the cryohydrates.

### Solution to Problem

The inventors of the present invention have made extensive investigations, and as a result, have found that when an alcoholic beverage to be imbibed at low temperature includes at least one of 0.021 wt % or more and 0.083 wt % or less of a mannan, or 0.0005 wt % or more and 0.011 wt % or less of agar, the occurrence of the coarsening of cryohydrates is suppressed. Thus, the inventors have reached the present invention.

That is, the present invention provides an alcoholic beverage to be imbibed at low temperature including: 2.0 vol % or more of an alcohol; 10 wt % to 85 wt % of cryohydrates each having a major axis length of from 0.01 mm to 5.0 mm; and at least one of 0.021 wt % or more and 0.083 wt % or less of a mannan, or 0.0005 wt % or more and 0.011 wt % or less of agar, wherein the alcoholic beverage to be imbibed at low temperature includes bubbles to have fluidity at a temperature of from −20° C. to −2° C.

The present invention also provides the alcoholic beverage to be imbibed at low temperature, wherein the alcoholic beverage to be imbibed at low temperature is obtained by mixing an alcoholic beverage base mix and ice pieces at a weight ratio of from 20:80 to 85:15, and subjecting the mixture to aeration, stirring, and cooling so that a volume fraction of a gas in the resultant becomes from 1% to 150%, and a product temperature thereof becomes less than −1° C., wherein the alcoholic beverage base mix contains the alcohol, and at least one of the mannan or the agar, and wherein 80 wt % or more of the ice pieces each have a major axis length of from 0.01 mm to 5.0 mm.

The present invention also provides a method of manufacturing an alcoholic beverage to be imbibed at low temperature including the steps of: mixing an alcoholic beverage base mix and ice pieces at a weight ratio of from 20:80 to 85:15; and subjecting the mixture to aeration, stirring, and cooling so that a volume fraction of a gas in the resultant becomes from 1% to 150%, and a product temperature thereof becomes less than −1° C., wherein the alcoholic beverage base mix contains 2.0 vol % or more of an alcohol with respect to the alcoholic beverage to be imbibed at low temperature, and at least one of 0.021 wt % or more and 0.083 wt % or less of a mannan with respect to the alcoholic beverage to be imbibed at low temperature, or 0.0005 wt % or more and 0.011 wt % or less of agar with respect to the alcoholic beverage to be imbibed at low temperature, and wherein 80 wt % or more of the ice pieces each have a major axis length of from 0.01 mm to 5.0 mm.

### Advantageous Effects of Invention

In the alcoholic beverage to be imbibed at low temperature that includes the cryohydrates and includes the bubbles to have the fluidity under a low-temperature condition, in particular, at a product temperature of from −20° C. to −2° C., the coarsening of the cryohydrates can be suppressed.

### DESCRIPTION OF EMBODIMENTS

Embodiments of the present invention are described below.

A first embodiment of the present invention is the following alcoholic beverage to be imbibed at low temperature.

An alcoholic beverage to be imbibed at low temperature including: 2.0 vol % or more of an alcohol; 10 wt % to 85 wt % of cryohydrates each having a major axis length of from 0.01 mm to 5.0 mm; and at least one of 0.021 wt % or more and 0.083 wt % or less of a mannan, or 0.0005 wt % or more and 0.011 wt % or less of agar, wherein the alcoholic beverage to be imbibed at low temperature includes bubbles to have fluidity at a temperature of from −20° C. to −2° C.

In addition, a second embodiment of the present invention is the following alcoholic beverage to be imbibed at low temperature.

The alcoholic beverage to be imbibed at low temperature, wherein the alcoholic beverage to be imbibed at low temperature is obtained by mixing an alcoholic beverage base mix and ice pieces at a weight ratio of from 20:80 to 85:15, and subjecting the mixture to aeration, stirring, and cooling so that a volume fraction of a gas in the resultant becomes from 1% to 150%, and a product temperature thereof becomes less than −1° C., wherein the alcoholic beverage base mix contains the alcohol, and at least one of the mannan or the agar, and wherein 80 wt % or more of the ice pieces each have a major axis length of from 0.01 mm to 5.0 mm (more preferably from 0.05 mm to 2.0 mm).

### (Alcoholic Beverage and Alcohol)

The term “alcoholic beverage” as used herein refers to an alcoholic beverage specified in Chapter 1, Article 2 of the Liquor Tax Act. The alcoholic beverage to be imbibed at low temperature refers to an alcoholic beverage that is imbibed at low temperature, in particular, at a product temperature of from −20° C. to −2° C.

The alcoholic beverage to be imbibed at low temperature of the present invention includes 2.0 vol % or more of the alcohol. When a content ratio in the alcoholic beverage to be imbibed at low temperature is specified in terms of volume ratio, the volume of the alcoholic beverage to be imbibed at low temperature except its bubbles is defined as 100%. That is, in the present invention, the beverage includes 2.0 vol % or more of the alcohol per volume except the bubbles. Any alcohol is used as the alcohol without any limitation as long as the alcohol is an edible alcohol. Specific examples thereof include ethyl alcohol (ethanol), glycerin, polyglycerin that is a polymer of glycerin, and propylene glycol. Of those, ethyl alcohol is preferred. That is, the alcoholic beverage to be imbibed at low temperature of the present invention preferably includes 2.0 vol % or more of ethyl alcohol, and more preferably includes 2.0 vol % to 9.0 vol % thereof. When the content of the alcohol is less than 2.0 vol %, in the first place, the following problem to be solved by the present invention hardly occurs: the coarsening of the cryohydrates is liable to occur owing to the low freezing point of the beverage. When the content of the alcohol is more than 9.0 vol %, the freezing point is so low that a desired alcoholic beverage to be imbibed at low temperature having, for example, fluidity at a temperature of from −20° C. to −2° C. and other palatability is not obtained.

### (Bubbles)

The alcoholic beverage to be imbibed at low temperature in the present invention includes the gas as the bubbles. For example, oxygen, nitrogen, a carbonic acid gas, air, an inert gas, or any other gas that may be typically used in food may be used as the gas without any limitation. When the volume of the alcoholic beverage to be imbibed at low temperature except the bubbles is defined as 100%, the percentage content of the bubbles is preferably from 1% to 150%.

### (Mannan)

The mannan refers to a polysaccharide containing D-mannose as a basic skeleton. The mannan is present in, for example, the seed, fruit, or tuber of a plant, the woody part of a coniferous tree, a microorganism, or seaweed. The mannan may be any one of a mannan whose constituent component is mostly D-mannose, a galactomannan containing galactose, and glucomannan containing glucose. A preferred example thereof is a mannan obtained from a konnyaku potato or the like. The mannan is available from various manufacturers.

The alcoholic beverage to be imbibed at low temperature of the present invention may include 0.021 wt % or more and 0.083 wt % or less of the mannan. Thus, the coarsening of the cryohydrates is suppressed.

### (Agar)

The agar is extracted from red algae, in particular, Gelidium amansii and Gracilaria asiatica, is a polysaccharide containing galactose as a basic skeleton, and is formed of neutral agarose and ionic agaropectin. Agar that is generally available may be used as the agar without any limitation. The agar is available from various manufacturers.

The alcoholic beverage to be imbibed at low temperature of the present invention may include 0.0005 wt % or more and 0.011 wt % or less of the agar. Thus, the coarsening of the cryohydrates is suppressed.

Although the alcoholic beverage to be imbibed at low temperature of the present invention only needs to include 0.021 wt % or more and 0.083 wt % or less of the mannan, or 0.0005 wt % or more and 0.011 wt % or less of the agar, the beverage most preferably includes 0.021 wt % or more and 0.083 wt % or less of the mannan, and 0.0005 wt % or more and 0.011 wt % or less of the agar. When the beverage includes those components, the coarsening of the cryohydrates is more effectively suppressed.

### (Cryohydrate and Ice Piece)

The terms “cryohydrate” and “ice piece” as used herein are described. The cryohydrate refers to the crystal of ice, and all of an ice block, an ice piece, an ice piece that has partly melted, and the crystal of ice produced by the crystallization of moisture during the freezing of a mixture are cryohydrates. Meanwhile, the ice piece is a subordinate concept of the cryohydrate, and refers to a cryohydrate to be loaded in a manufacturing process for the alcoholic beverage to be imbibed at low temperature out of the cryohydrates. Although a method of obtaining the ice piece is not particularly limited, the ice piece may be preferably obtained as follows: an ice block having a volume of 1 cm³ or more is subjected to cutting, crushing, or the like; or the cryohydrates are classified, or are subjected to cutting, crushing, or the like, and are then classified. An example of the classification is sieving.

In the alcoholic beverage to be imbibed at low temperature of the present invention, the cryohydrates include cryohydrates derived from ice pieces added during its manufacture, that is, the added ice pieces themselves, products obtained by the partial melting of ice pieces, products obtained by the freezing thereof, and the crystals of ice that are not derived from ice pieces and are produced by the crystallization of moisture during the freezing of a mixture.

The alcoholic beverage to be imbibed at low temperature of the present invention includes 10 wt % to 85 wt % of the cryohydrates each having a major axis length of from 0.01 mm to 5.0 mm. As a result of the incorporation of such cryohydrates, the alcoholic beverage to be imbibed at low temperature provides a cool feeling to its imbiber. The alcoholic beverage to be imbibed at low temperature of the present invention more preferably includes 50 wt % or more of cryohydrates each having a major axis length of from 0.05 mm to 1.5 mm. The alcoholic beverage to be imbibed at low temperature of the present invention still more preferably includes 50 wt % or more of cryohydrates each having a major axis length of from 0.07 mm to 1.5 mm. The incorporation of 50 wt % or more of the cryohydrates each having a major axis length of from 0.05 mm to 1.5 mm can cause the imbiber to perceive the cryohydrates, and hence can provide a higher cool feeling thereto.

In the second embodiment, the alcoholic beverage to be imbibed at low temperature is obtained through a step of mixing the alcoholic beverage base mix and the ice pieces. The weight ratio between the alcoholic beverage base mix and the ice pieces is preferably from 20:80 to 85:15, and the weight ratio is more preferably from 20:80 to 80:25. In Examples below, the weight ratio between the base mix and the ice pieces is 50:50. 80 Weight percent or more of the ice pieces to be mixed each have a major axis length of preferably from 0.01 mm to 5.0 mm, more preferably from 0.05 mm to 2.0 mm, still more preferably from 0.1 mm to 1.2 mm, still more preferably from 0.1 mm to 1.0 mm, or still more preferably from 0.1 mm to 0.8 mm. The mixing of such ice pieces contributes to the fact that the alcoholic beverage to be imbibed at low temperature preferably includes 50 wt % or more of the cryohydrates each having a major axis length of from 0.05 mm to 1.5 mm, and more preferably includes 50 wt % or more of the cryohydrates each having a major axis length of from 0.07 mm to 1.5 mm.

In the second embodiment, the ice pieces are preferably classified before being mixed with the alcoholic beverage base mix, and the classification is preferably performed with a sieve having an aperture of, for example, from 0.8 mm to 2.0 mm.

### (Fluidity)

The alcohol reduces the freezing temperature of an alcoholic beverage. The alcoholic beverage to be imbibed at low temperature of the present invention includes 2.0 vol % or more of the alcohol, and hence its freezing temperature is low enough to make it difficult for the beverage to harden in a solid state. Accordingly, the alcohol contributes to the fact that the beverage has such fluidity as to be capable of being imbibed at a temperature of from −20° C. to −2° C., preferably from −15° C. to −2° C., more preferably from −12° C. to −4° C. The phrase “to be imbibed” means that the alcoholic beverage to be imbibed at low temperature stored in a cup, a glass, a plugged container, or the like can be eaten as follows without application of an operation such as scooping or raking with a spoon or the like, or squeezing with a grip strength of 30 kg or more: the beverage is eaten with, for example, a straw and/or a utensil similar thereto, or by being sucked from a plug; or the beverage is eaten by being flowed into a mouth through the tilting of the container through utilization of its fluidity. However, needless to say, the alcoholic beverage to be imbibed at low temperature of the present invention does not inhibit eating with a spoon or the like except direct imbibition from the container.

That is, the alcoholic beverage to be imbibed at low temperature of the present invention can be preferably sucked in with a straw or the like, eaten by being sucked from a plug, pushed out by being squeezed with a grip strength of less than 30 kg, or naturally flowed through the tilting of its container at a temperature of from −15° C. to −2° C., more preferably from −12° C. to −4° C.

### (Alcoholic Beverage Base Mix)

In the second embodiment, the alcoholic beverage to be imbibed at low temperature is obtained by mixing the alcoholic beverage base mix and the ice pieces, and subjecting the mixture to the aeration, the stirring, and the cooling. The alcoholic beverage base mix corresponds to a raw material mixture before the mixing with the ice pieces, and contains the alcohol, and at least one of the mannan or the agar.

The freezing temperature of the alcoholic beverage to be imbibed at low temperature depends on the melt starting temperature of the alcoholic beverage base mix. To obtain an alcoholic beverage to be imbibed at low temperature having fluidity under a temperature condition of from −20° C. to −2° C., the melt starting temperature of the alcoholic beverage base mix measured with a differential scanning calorimeter is preferably −2° C. or less, more preferably from −20° C. to −2° C.

The alcoholic beverage to be imbibed at low temperature of the present invention and the alcoholic beverage base mix each preferably include a saccharide or a sugar alcohol, and may each include an acidulant, a salt, a protein, or the like. Those substances may each contribute to the impartment of a taste or a reduction in freezing temperature of the alcoholic beverage to be imbibed at low temperature.

Specifically, a monosaccharide, such fructose or glucose, a disaccharide, such as sugar, trehalose, maltose, or lactose, any of various oligosaccharides, such as maltotriose, maltotetraose, fructo-oligosaccharide, galacto-oligosaccharide, xylo-oligosaccharide, or gentio-oligosaccharide, any of various starch syrups, powdered candy, or honey is suitable as the saccharide. In addition, a dietary fiber such as polydextrose may be incorporated into the alcoholic beverage base mix as in the starch syrup and the powdered candy.

Specifically, xylitol, lactitol, maltitol, sorbitol, mannitol, or reduced starch syrup is suitable as the sugar alcohol.

Specifically, an edible acid, such as citric acid, malic acid, or tartaric acid, or a salt thereof is suitable as the acidulant.

Specifically, a general edible salt, such as sodium chloride or potassium chloride, is suitable as the salt.

An edible protein, such as milk protein, soybean protein, wheat protein, or pea protein, or a general protein-containing food, such as a dairy product or soybean milk, is suitable as the protein.

In consideration of, for example, the taste, viscosity, and freezing temperature of the alcoholic beverage to be imbibed at low temperature, a substance appropriately selected from the substances listed above is added in an appropriate amount.

### (Stabilizer)

The mannan and the agar may be called stabilizers because the mannan and the agar each suppress the coarsening of the cryohydrates to contribute to stable storage of the alcoholic beverage to be imbibed at low temperature. In addition to the mannan and/or the agar, an additional stabilizer may be added to each of the alcoholic beverage to be imbibed at low temperature of the present invention and the alcoholic beverage base mix. Examples of the stabilizer include a polysaccharide thickener, pectin, and gelatin. Examples of the polysaccharide thickener include locust bean gum, guar gum, carrageenan, tamarind seed gum, xanthan gum, and cellulose.

The additional stabilizer is preferably, for example, any one of locust bean gum, tamarind seed gum, and cellulose, or two or more of these stabilizers, and the addition amount of each of the stabilizers may be, for example, as follows: the addition amount of the locust bean gum is 0.031 wt % or more and 0.134 wt % or less; the addition amount of the tamarind seed gum is 0.039 wt % or more and 0.165 wt % or less; and the addition amount of the cellulose is 0.005 wt % or more and 0.052 wt % or less.

Those stabilizers each contribute to the prevention of the coarsening of the cryohydrates or the impartment of a smooth imbibition feeling to the alcoholic beverage to be imbibed at low temperature. However, the addition amount of each of the stabilizers is appropriately determined in accordance with the kind thereof, and is preferably such that the alcoholic beverage to be imbibed at low temperature neither has such high viscosity as to be incapable of being sucked with a straw nor gels.

### (Other Additive)

Alternatively, to improve a taste, the alcoholic beverage to be imbibed at low temperature of the present invention and the alcoholic beverage base mix may each include any one of: the fruit juice or fruit pulp of each of various fruits, such as a lemon, an orange, a grapefruit, a strawberry, a melon, a banana, a mango, and a pineapple; mesophyll; seeds such as a nut; dairy products, such as milk, cream, condensed milk, and fermented milk; extracts, such as coffee and tea, and condensates thereof, finely pulverized products of coffee, tea, powdered green tea, and the like; and gel-like foods each solidified by agar or gelatin. In addition, a conventionally known foaming agent such as a protein decomposition product may be incorporated for increasing the percentage content of the bubbles of the beverage.

### (Oil and Fat)

The alcoholic beverage to be imbibed at low temperature of the present invention and the alcoholic beverage base mix may each include an oil and fat. An oil and fat whose melting point falls within a minus temperature range such as a medium chain triglyceride is desirably used as the oil and fat because the fluidity of the beverage at low temperature is further improved. However, the oil and fat to be used is not particularly limited as long as the oil and fat is a generally edible oil and fat.

### (Aeration)

The alcoholic beverage to be imbibed at low temperature in the present invention includes the gas as the bubbles, and preferably includes the gas as the bubbles so that the volume fraction of the gas becomes from 1% to 150%. For example, oxygen, nitrogen, a carbonic acid gas, air, an inert gas, or any other gas that may be typically used in food may be used as the gas without any limitation.

The aeration refers to the incorporation of the gas into an object, and the gas is preferably incorporated as fine bubbles each having a size of about several hundreds of micrometers by stirring. The gas may be incorporated with an apparatus that can perform the aeration, the stirring, and cooling such as a batch-type ice cream freezer. The aeration may be performed at any stage of a manufacturing process for the alcoholic beverage to be imbibed at low temperature. For example, the aeration may be performed in advance before the stirring and the cooling, may be performed in tandem with the stirring and the cooling, or may be separately performed anew after the stirring and the cooling.

The gas imparts moderate softness to the alcoholic beverage to be imbibed at low temperature, and when the alcoholic beverages to be imbibed at low temperature having the same freezing temperature are compared to each other, as the content of the gas increases, the beverages each have softer mouthfeel. However, when the content is excessively large, the beverages may be poor in fluidity. In addition, the incorporation of the gas reduces the heat capacity of the alcoholic beverage to be imbibed at low temperature, which enters a mouth, per volume, and hence the following effect is obtained: even when the beverage is imbibed at low temperature, damage to an oral cavity, a throat, or the like is prevented.

### (Product Temperature)

The alcoholic beverage to be imbibed at low temperature of the present invention is desirably imbibed at a temperature of preferably from −20° C. to −2° C., more preferably from −15° C. to −2° C., still more preferably from −12° C. to −4° C. Although the alcoholic beverage to be imbibed at low temperature of the present invention may be imbibed even at a temperature of more than −2° C., the cool feeling that is a feature of the beverage may be hardly obtained because its cryohydrates melt, and hence the beverage no longer includes 10 wt % to 85 wt % of cryohydrates each having a major axis length of from 0.01 mm to 1.5 mm.

The preparation of the alcoholic beverage to be imbibed at low temperature of the present invention so that the beverage has fluidity at a temperature of less than −20° C. that is the lower limit temperature is technically possible by, for example, increasing its alcohol concentration and/or sugar concentration to reduce its freezing temperature. However, the coarsening of the cryohydrates is more liable to occur. In addition, in such case, the alcohol feeling and sweetness of the beverage become excessively strong, and hence the palatability thereof becomes poor. Moreover, when the beverage is imbibed at a low temperature of less than −15° C., the temperature of an oral cavity or a throat may become excessively low to cause frostbite. Accordingly, it is undesirable to maintain the fluidity of the beverage at extremely low temperature. The alcoholic beverage to be imbibed at low temperature of the present invention is desirably imbibed at a product temperature of −20° C. or more.

The present invention provides, as a third embodiment, a method of manufacturing an alcoholic beverage to be imbibed at low temperature including the steps of: mixing an alcoholic beverage base mix and ice pieces at a weight ratio of from 20:80 to 85:15; and subjecting the mixture to aeration, stirring, and cooling so that a volume fraction of a gas in the resultant becomes from 1% to 150%, and a product temperature thereof becomes less than −1° C., wherein the alcoholic beverage base mix contains 2.0 vol % or more of an alcohol with respect to the alcoholic beverage to be imbibed at low temperature, and at least one of 0.021 wt % or more and 0.083 wt % or less of a mannan with respect to the alcoholic beverage to be imbibed at low temperature, or 0.0005 wt % or more and 0.011 wt % or less of agar with respect to the alcoholic beverage to be imbibed at low temperature, and wherein 80 wt % or more of the ice pieces each have a major axis length of from 0.01 mm to 5.0 mm.

Details about this embodiment are as described above. This embodiment may further include a step of loading the resultant alcoholic beverage to be imbibed at low temperature into a container for sale, and the container for sale may be, for example, a plugged container such as CHEER PACK (trademark). In addition, this embodiment may further include a step of hardening the beverage. The hardening step is preferably performed as follows: the manufactured alcoholic beverage to be imbibed at low temperature is loaded into the container, and is then hardened by freezing under a temperature condition of −20° C. or less.

### EXAMPLES

### Preparation of Example 1

### Preparation of Alcoholic Beverage Base Mix

Sugar, locust bean gum, tamarind seed gum, a mannan, agar, microcrystalline cellulose, any other stabilizer, and water were mixed. A mannan that was derived from a konnyaku potato, was treated with an alcohol, and was formed mainly of a mannose was used as the mannan. Agar derived from Gracilaria asiatica was used as the agar. The mixed materials were warmed to 85° C. while being stirred and mixed. After that, the mixture was quickly cooled in ice water to provide a sugar solution mix at 5° C. 42 Volume percent of the sugar solution mix and 8.4 vol % of commercial vodka (59°) were added and mixed so that an entire mass became 2.0 kg. Thus, an alcoholic beverage base mix was prepared. The composition of the base mix is shown in Table 1. In Table 1, the content of an alcohol is represented in the unit of vol % while the volume of the resultant alcoholic beverage to be imbibed at low temperature except its bubbles is defined as 100%, and the content of any other substance is represented in the unit of wt % in the resultant alcoholic beverage to be imbibed at low temperature.

### Preparation of Ice Pieces

4 Kilograms of an ice block was cut with an ice-shaving machine, and the resultant shaved ice was stored under the condition of −35° C. After that, the ice was further crushed with a hammer, and then a fraction having a length of less than about 1.0 mm was obtained by using a sieve having an aperture of 1.0 mm. Next, the fraction was sorted into a staying portion and a passing portion with a sieve having an aperture of 0.1 mm. Thus, 3,400 g of the staying portion was obtained, and the portion was used as ice pieces. The ice pieces were observed with a microscope. As a result, ice pieces each having a size of less than 0.1 mm and ice pieces each having a size of more than 1.0 mm were substantially absent, and the sizes of substantially all the ice pieces each fell within the range of from 0.1 mm to 1.0 mm.

### Preparation of Alcoholic Beverage to be Imbibed at Low Temperature

2 Kilograms of the prepared ice pieces each having a size of from 0.1 mm to 1.0 mm, which had been held in a thermostat at −10° C., and 2 kg of the above-mentioned alcoholic beverage base mix cooled to −3° C. were mixed, and then the mixture was subjected to aeration, stirring, and cooling in tandem with a batch-type ice cream freezer. Thus, 3,700 g of a semi-frozen alcoholic beverage to be imbibed at low temperature having an air content of 20 vol % was obtained. The beverage was loaded in portions of about 140 ml each into CHEER PACKs each having a plastic-made tap and a volume of 140 ml. Those CHEER PACKs were held in a quick freezer at −40° C. for 1 hour so that their contents were hardened. Thus, an alcoholic beverage to be imbibed at low temperature of Example 1 was obtained.

### With Regard to Examples 2 to 8 and Comparative Example

Alcoholic beverages to be imbibed at low temperature of Examples 2 to 5 were each prepared in the same manner as in Example 1 except that the content ratio of the alcohol was changed as shown in Table 1.

Alcoholic beverages to be imbibed at low temperature of Examples 6 and 7 were each prepared in the same manner as in Example 1 except that the content ratios of the mannan and the agar were changed as shown in Table 1.

An alcoholic beverage to be imbibed at low temperature of Example 8 was prepared in the same manner as in Example 1 except that the mannan was not added.

An alcoholic beverage to be imbibed at low temperature of Comparative Example was prepared in the same manner as in Example 1 except that neither the mannan nor the agar was added.

### <Quality Verification Test>

The alcoholic beverages to be imbibed at low temperature of Examples 1 to 8 and Comparative Example thus obtained were used as the respective samples, and heat shock was applied to each of the samples for 6 days. In the heat shock, the following was continued for 6 days: the temperature of each of the samples was held at −20° C. for 4 hours; then, the temperature was increased to −5° C. over 30 minutes, and was held at −5° C. for 2 hours; and then, the temperature was decreased to −20° C. over 30 minutes.

The samples were each subjected to a sensory test after the heat shock. The temperature of each of the samples to be subjected to the sensory test was held at −20° C. for 12 hours before the test. In the sensory test, two panelists who were each in his or her forties imbibed each of the samples, and evaluated the sample based on the following indicators.

++: The coarsening of cryohydrates does not occur, and hence mouthfeel and fluidity are the same as those in the case where no heat shock is applied. The sample has quality sufficient as a commercial product.

+: The coarsening of cryohydrates slightly occurs, and hence mouthfeel and fluidity are different from those in the case where no heat shock is applied. When a countermeasure such as the setting of an open date is taken, the sample can be provided as a commercial product.

−: The coarsening of cryohydrates occurs, and hence quality is clearly different from that in the case where no heat shock is applied. The sample cannot be provided as a commercial product because the sample has low fluidity, and is hence difficult to discharge and suck from a plugged container.

The results are shown in Table 1. It was recognized that even in an alcoholic beverage to be imbibed at low temperature that included only the mannan and was free of the agar, the coarsening of its cryohydrates did not occur, and hence its commercial value was not impaired, though the result was not shown.

TABLE 1

| | | | Exam- | Exam- | Exam- | Exam- | Exam- | Exam- | Exam- | Exam- | Comparative |
|---|---|---|---|---|---|---|---|---|---|---|---|
| | | | ple 1 | ple 2 | ple 3 | ple 4 | ple 5 | ple 6 | ple 7 | ple 8 | Example 1 |
| Alcohol | | (vol %/product) | 5.5 | 2.0 | 4.0 | 7.0 | 9.0 | 5.5 | 5.5 | 5.3 | 5.5 |
| Stabilizer | Locust bean gum | (wt %/product) | 0.067 | 0.075 | 0.070 | 0.068 | 0.064 | 0.133 | 0.032 | 0.124 | 0.067 |
| | Tamarind seed gum | | 0.082 | 0.092 | 0.086 | 0.083 | 0.079 | 0.164 | 0.040 | 0.076 | 0.082 |
| | Mannan | | 0.0416 | 0.0469 | 0.0439 | 0.0422 | 0.0400 | 0.0831 | 0.0208 | — | — |
| | Agar | | 0.0012 | 0.0014 | 0.0013 | 0.0012 | 0.0012 | 0.0024 | 0.0005 | 0.0107 | — |
| | Microcrystalline | | 0.006 | 0.007 | 0.006 | 0.006 | 0.006 | 0.012 | 0.002 | 0.051 | 0.006 |
| | cellulose | | | | | | | | | | |
| | Others | | 0.018 | 0.020 | 0.019 | 0.018 | 0.017 | 0.036 | 0.009 | 0.013 | 0.018 |

| | | | | | | | | | |
|---|---|---|---|---|---|---|---|---|---|
| Ice crystal increase-suppressing effect | ++ | ++ | ++ | + | + | + | + | + | − |

The present invention includes the following embodiments.

(1) An alcoholic beverage to be imbibed at low temperature including: 2.0 vol % or more of an alcohol; 10 wt % to 85 wt % of cryohydrates each having a major axis length of from 0.01 mm to 5.0 mm; and at least one of 0.021 wt % or more and 0.083 wt % or less of a mannan, or 0.0005 wt % or more and 0.011 wt % or less of agar, wherein the alcoholic beverage to be imbibed at low temperature includes bubbles to have fluidity at a temperature of from −20° C. to −2° C.

(2) An alcoholic beverage to be imbibed at low temperature including: 2.0 vol % or more of an alcohol; 10 wt % to 85 wt % of cryohydrates each having a major axis length of from 0.01 mm to 5.0 mm; and 0.021 wt % or more and 0.083 wt % or less of a mannan, wherein the alcoholic beverage to be imbibed at low temperature includes bubbles to have fluidity at a temperature of from −20° C. to −2° C.

(3) An alcoholic beverage to be imbibed at low temperature including: 2.0 vol % or more of an alcohol; 10 wt % to 85 wt % of cryohydrates each having a major axis length of from 0.01 mm to 5.0 mm; and 0.0005 wt % or more and 0.011 wt % or less of agar, wherein the alcoholic beverage to be imbibed at low temperature includes bubbles to have fluidity at a temperature of from −20° C. to −2° C.

(4) An alcoholic beverage to be imbibed at low temperature including: 2.0 vol % or more of an alcohol; 10 wt % to 85 wt % of cryohydrates each having a major axis length of from 0.01 mm to 5.0 mm; 0.021 wt % or more and 0.083 wt % or less of a mannan; and 0.0005 wt % or more and 0.011 wt % or less of agar, wherein the alcoholic beverage to be imbibed at low temperature includes bubbles to have fluidity at a temperature of from −20° C. to −2° C.

(5) The alcoholic beverage to be imbibed at low temperature according to any one of Items (1) to (4), wherein the alcoholic beverage to be imbibed at low temperature is obtained by mixing an alcoholic beverage base mix and ice pieces at a weight ratio of from 20:80 to 85:15, and subjecting the mixture to aeration, stirring, and cooling so that a volume fraction of a gas in the resultant becomes from 1% to 150%, and a product temperature thereof becomes less than −1° C., wherein the alcoholic beverage base mix contains the alcohol, and at least one of the mannan or the agar, and wherein 80 wt % or more of the ice pieces each have a major axis length of from 0.01 mm to 5.0 mm.

(6) The alcoholic beverage to be imbibed at low temperature according to any one of Items (1) to (5), wherein the alcoholic beverage to be imbibed at low temperature includes 50 wt % or more of cryohydrates each having a major axis length of from 0.05 mm to 1.5 mm, and the cryohydrates are perceived at a time of imbibition thereof.

(7) The alcoholic beverage to be imbibed at low temperature according to any one of Items (1) to (6), further including at least one of an oil and fat or a stabilizer.

(8) The alcoholic beverage to be imbibed at low temperature according to any one of Items (1) to (7), further including at least one or more of fruit juice, a fruit, fruit pulp, mesophyll, a seed, or a gel-like food.

(9) The alcoholic beverage to be imbibed at low temperature according to any one of Items (1) to (8), wherein the alcoholic beverage to be imbibed at low temperature is loaded into a plugged container.

(10) A method of manufacturing an alcoholic beverage to be imbibed at low temperature including the steps of: mixing an alcoholic beverage base mix and ice pieces at a weight ratio of from 20:80 to 85:15; and subjecting the mixture to aeration, stirring, and cooling so that a volume fraction of a gas in the resultant becomes from 1% to 150%, and a product temperature thereof becomes less than −1° C., wherein the alcoholic beverage base mix contains 2.0 vol % or more of an alcohol with respect to the alcoholic beverage to be imbibed at low temperature, and at least one of 0.021 wt % or more and 0.083 wt % or less of a mannan with respect to the alcoholic beverage to be imbibed at low temperature, or 0.0005 wt % or more and 0.011 wt % or less of agar with respect to the alcoholic beverage to be imbibed at low temperature, and wherein 80 wt % or more of the ice pieces each have a major axis length of from 0.01 mm to 5.0 mm.

(11) A method of manufacturing an alcoholic beverage to be imbibed at low temperature including the steps of: mixing an alcoholic beverage base mix and ice pieces at a weight ratio of from 20:80 to 85:15; and subjecting the mixture to aeration, stirring, and cooling so that a volume fraction of a gas in the resultant becomes from 1% to 150%, and a product temperature thereof becomes less than −1° C., wherein the alcoholic beverage base mix contains 2.0 vol % or more of an alcohol with respect to the alcoholic beverage to be imbibed at low temperature, 0.021 wt % or more and 0.083 wt % or less of a mannan with respect to the alcoholic beverage to be imbibed at low temperature, and 0.0005 wt % or more and 0.011 wt % or less of agar with respect to the alcoholic beverage to be imbibed at low temperature, and wherein 80 wt % or more of the ice pieces each have a major axis length of from 0.01 mm to 5.0 mm.

(12) The method of manufacturing an alcoholic beverage to be imbibed at low temperature according to Item (10) or (11), wherein the method is used for manufacture of the alcoholic beverage to be imbibed at low temperature of any one of Items (1) to (9).

(13) The method of manufacturing an alcoholic beverage to be imbibed at low temperature according to any one of Items (10) to (12), further including, after the step of subjecting the mixture to the aeration, the stirring, and the cooling, a step of hardening the resultant.

This application claims the benefit of priority from Japanese Patent Application No. 2022-102251, filed on Jun. 24, 2022, the content of which is incorporated herein by reference.

1. An alcoholic beverage to be imbibed at low temperature comprising:
2.0 vol % or more of an alcohol;
10 wt % to 85 wt % of cryohydrates each having a major axis length of from 0.01 mm to 5.0 mm; and
at least one of 0.021 wt % or more and 0.083 wt % or less of a mannan, or 0.0005 wt % or more and 0.011 wt % or less of agar,
wherein the alcoholic beverage to be imbibed at low temperature comprises bubbles to have fluidity at a temperature of from −20° C. to −2° C.

2. The alcoholic beverage to be imbibed at low temperature according to claim 1, wherein the alcoholic beverage to be imbibed at low temperature comprises 50 wt % or more of cryohydrates each having a major axis length of from 0.05 mm to 1.5 mm, and the cryohydrates are perceived at a time of imbibition thereof.

3. The alcoholic beverage to be imbibed at low temperature according to claim 1,
wherein the alcoholic beverage to be imbibed at low temperature is obtained by mixing an alcoholic beverage base mix and ice pieces at a weight ratio of from 20:80 to 85:15, and subjecting the mixture to aeration, stirring, and cooling so that a volume fraction of a gas in the resultant becomes from 1% to 150%, and a product temperature thereof becomes less than −1° C.,
wherein the alcoholic beverage base mix contains
the alcohol, and
at least one of the mannan or the agar, and
wherein 80 wt % or more of the ice pieces each have a major axis length of from 0.01 mm to 5.0 mm.

4. The alcoholic beverage to be imbibed at low temperature according to claim 3, wherein the alcoholic beverage to be imbibed at low temperature comprises 50 wt % or more of cryohydrates each having a major axis length of from 0.05 mm to 1.5 mm, and the cryohydrates are perceived at a time of imbibition thereof.

5. An alcoholic beverage to be imbibed at low temperature comprising:
2.0 vol % or more of an alcohol;
10 wt % to 85 wt % of cryohydrates each having a major axis length of from 0.01 mm to 5.0 mm;
0.021 wt % or more and 0.083 wt % or less of a mannan; and
0.0005 wt % or more and 0.011 wt % or less of agar,
wherein the alcoholic beverage to be imbibed at low temperature comprises bubbles to have fluidity at a temperature of from −20° C. to −2° C.

6. The alcoholic beverage to be imbibed at low temperature according to claim 5, wherein the alcoholic beverage to be imbibed at low temperature comprises 50 wt % or more of cryohydrates each having a major axis length of from 0.05 mm to 1.5 mm, and the cryohydrates are perceived at a time of imbibition thereof.

7. The alcoholic beverage to be imbibed at low temperature according to claim 5-r 6,
wherein the alcoholic beverage to be imbibed at low temperature is obtained by mixing an alcoholic beverage base mix and ice pieces at a weight ratio of from 20:80 to 85:15, and subjecting the mixture to aeration, stirring, and cooling so that a volume fraction of a gas in the resultant becomes from 1% to 150%, and a product temperature thereof becomes less than −1° C.,
wherein the alcoholic beverage base mix contains
the alcohol, and
at least one of the mannan or the agar, and
wherein 80 wt % or more of the ice pieces each have a major axis length of from 0.01 mm to 5.0 mm.

8. The alcoholic beverage to be imbibed at low temperature according to claim 5, wherein the alcoholic beverage to be imbibed at low temperature comprises 50 wt % or more of cryohydrates each having a major axis length of from 0.05 mm to 1.5 mm, and the cryohydrates are perceived at a time of imbibition thereof.

9. The alcoholic beverage to be imbibed at low temperature according to claim 1, further comprising at least one of an oil and fat or a stabilizer.

10. The alcoholic beverage to be imbibed at low temperature according to claim 1, further comprising at least one of fruit juice, a fruit, fruit pulp, mesophyll, a seed, or a gel-like food.

11. The alcoholic beverage to be imbibed at low temperature according to claim 1, wherein the alcoholic beverage to be imbibed at low temperature is loaded into a plugged container.

12. A method of manufacturing an alcoholic beverage to be imbibed at low temperature comprising the steps of:
mixing an alcoholic beverage base mix and ice pieces at a weight ratio of from 20:80 to 85:15; and
subjecting the mixture to aeration, stirring, and cooling so that a volume fraction of a gas in the resultant becomes from 1% to 150%, and a product temperature thereof becomes less than −1° C.,
wherein the alcoholic beverage base mix contains
2.0 vol % or more of an alcohol with respect to the alcoholic beverage to be imbibed at low temperature, and
at least one of 0.021 wt % or more and 0.083 wt % or less of a mannan with respect to the alcoholic beverage to be imbibed at low temperature, or 0.0005 wt % or more and 0.011 wt % or less of agar with respect to the alcoholic beverage to be imbibed at low temperature, and
wherein 80 wt % or more of the ice pieces each have a major axis length of from 0.01 mm to 5.0 mm.

13. A method of manufacturing an alcoholic beverage to be imbibed at low temperature comprising the steps of:
mixing an alcoholic beverage base mix and ice pieces at a weight ratio of from 20:80 to 85:15; and
subjecting the mixture to aeration, stirring, and cooling so that a volume fraction of a gas in the resultant becomes from 1% to 150%, and a product temperature thereof becomes less than −1° C.,
wherein the alcoholic beverage base mix contains
2.0 vol % or more of an alcohol with respect to the alcoholic beverage to be imbibed at low temperature,
0.021 wt % or more and 0.083 wt % or less of a mannan with respect to the alcoholic beverage to be imbibed at low temperature, and
0.0005 wt % or more and 0.011 wt % or less of agar with respect to the alcoholic beverage to be imbibed at low temperature, and
wherein 80 wt % or more of the ice pieces each have a major axis length of from 0.01 mm to 5.0 mm.

14. The method of manufacturing an alcoholic beverage to be imbibed at low temperature according to claim 12, further comprising, after the step of subjecting the mixture to the aeration, the stirring, and the cooling, a step of hardening the resultant.
